(19) United States
(12) Patent Application Publication
(10) Pub. No.: US 2007/0021538 A1
(43) Pub. Date: Jan. 25, 2007

(54) Polymer composition comprising a polymer resin and a carboxylate phosphinate salt compound

(76) Inventors: Su Hak Bae, Seoul (KR); Sang Hyun Hong, Gunpo-Si (KR); Jeong Hwan Ku, Gunpo-Si (KR); Jin Hwan Choi, Anyang-Si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/320,154

(22) Filed: Dec. 28, 2005

(30) Foreign Application Priority Data
Jul. 22, 2005 (KR) KR 2005-66706

(51) Int. Cl. C08K 5/52

(52) U.S. Cl. 524/127; 524/556; 524/565

(57) ABSTRACT

A polymer composition includes a polymer resin and a carboxylate phosphinate salt compound. The polymer composition can include a thermoplastic resin and a carboxylate phosphinate salt compound. A molded article and electronic devices can be made from the polymer composition.

### BACKGROUND OF THE INVENTION

1. Field of the Invention

This invention relates to a flame retardant polymer compositions, and more particularly those comprising a carboxylate phosphinate salt compound. This invention further relates to a molded article and electronic devices comprising the polymer composition and methods of making the same.

2. Description of the Related Art

In general, thermoplastic resins are used in almost all electronic products, owing to its good processability and mechanical properties. However, the thermoplastic resin by itself has little to no flame retardancy. One method of increasing flame retardancy of thermoplastic resins is the inclusion of a halogenated compound and antimony oxide. However, this method is not favorable because of the inclusion of halogen containing compounds which have a detrimental effect to the environment, including human health. As such, there is a present need for the design of thermoplastic resins which contain other flame retardant compounds which are safer to the environment and for human use.

### SUMMARY OF THE INVENTION

One aspect of the present invention is a polymer composition which includes a polymer resin; and a carboxylate phosphinate acid salt compound. An example of the carboxylate phosphinate acid salt compound has the following structure: 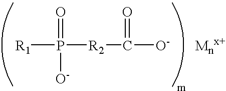
wherein R₁ is independently selected from a C₁-C₆ alkyl group, a C₃-C₁₀ cycloalkyl group, and a C₆-C₁₀ aryl group; R₂ is independently selected from a C₁-C₆ alkylene group, a C₃-C₁₀ cycloalkylene group, and a C₆-C₁₀ arylene group; M is selected from the group consisting of Al, Zn, Ca, and a melamine; m and n are independently an integer from 1 to 3; and x is an integer selected so that the net charge of the carboxylate phosphinate acid salt compound is 0.

In some embodiments, the polymer composition can be substantially free of halogen-containing compounds. The polymer resin in some embodiments is a thermoplastic resin. The polymer resin can be one or a mixture of two or more selected from the group consisting of polystyrene resin (PS resin), acrylonitrile-butadiene-styrene copolymer resin (ABS resin), rubber-modified polystyrene resin (HIPS resin), acrylonitrile-strene-acrylate copolymer resin (ASA resin), acrylonitrile-styrene copolymer resin (SAN resin), methylmethacrylate-butadiene-styrene copolymer resin (MBS resin), acrylonitrile-ethylacrylate-styrene copolymer resin (AES resin), polycarbonate resin (PC), polyphenylene ether resin (PPE), polyethylene resin (PE), polypropylene resin (PP), polyethylene terephthalate (PET), polybutylene terephthalate (PBT), polymethyl methacrylate (PMMA), polyamide resin (PA), and copolymers thereof.

The polymer composition in some embodiments also includes: 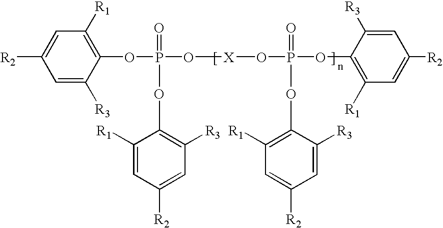
wherein R₁, R₂ and R₃ on each phenyl group are each independently hydrogen or C₁₋₄ alkyl and are independent of R₁, R₂, and R₃ on a different phenyl group; X is derived from a compound comprising two hydroxyaryl groups; and n is 0 to 4.

The polymer composition can include the polymer resin from about 60 to about 99.9 parts, more preferably from about 70 to about 98 parts, still more preferably from about 75 to about 97 parts, yet more preferably from about 75 to about 95 parts, and even more preferably from about 80 to about 92 parts, and the carboxylate phosphinate acid salt compound from about 0.1 to about 40 parts by weight, more preferably from about 2 to about 30 parts by weight, still more preferably from about 3 to about 25 parts by weight, yet more preferably from about 5 to about 25 parts by weight, and even more preferably from about 8 to about 20 parts by weight, based on the polymer resin and the carboxylate phosphinate acid salt compound totaling 100 parts by weight.

A molded article can be made from the aforementioned polymer composition. It is advantageous if the molded article has flame retardancy of at least V-1, more preferably V-0, when a specimen of the composition is tested according to UL-94VB at a thickness of 1/10″. It is also advantageous if the molded article exhibits good thermal stability of sample color when a specimen of the composition is exposed to 270° C. for 10 minutes. Another advantageous property of the molded article is if the article exhibits a hygroscopicity less than 1.8%.

Another aspect of the present invention relates to a method of making a plastic structure. This method includes providing the polymer composition described above; and molding the polymer composition into a shape.

Still another aspect of the invention relates to a method of making an electronic device. This method includes providing an electronic circuit; and providing a housing substantially enclosing the electronic circuit. The housing has at least a portion, which is made of the aforementioned polymer composition.

One more aspect of the invention relates to an electronic device that includes a housing. In this aspect, the housing includes a portion that is made of the polymer composition described above.

### DETAILED DESCRIPTION OF THE PREFERRED EMBODIMENT

An advantage of certain embodiments is to provide a thermoplastic resin composition having fire stability. Another advantage of some embodiments is to provide a flame-retardant thermoplastic resin composition which is environmentally safe because the composition comprises substantially no halogens which may cause environmental pollution upon the processing or burning of resin. Some embodiments also have good thermal stability and low hygroscopicity.

As noted above, one aspect of this invention relates to a polymer composition comprising a polymer resin and a carboxylate phosphinate salt compound. The molded articles of the polymer composition embodiments show enhanced physical or mechanical properties as compared to other polymer resins less the carboxylate phosphinate salt compound. The molded articles of the embodiments may also show enhanced physical or mechanical properties as compared to other molded articles comprising polymer resins and a carboxylate phosphinate compound. The polymer compositions of the embodiments also demonstrate improved flowability over compositions less one or more components. As will be discussed, the molded compositions according to embodiments of the invention have good impact resistance, impact strength, and melt index, while maintaining excellent thermal stability.

As compared to polymer compositions comprises a carboxy phosphinic acid compound, the polymer compositions comprising a carboxylate phosphinate salt compound in some embodiments demonstrate enhanced thermal resistance, thermal stability of the sample color, and hygroscopicty. Polymer composition comprising the carboxylate phosphonate salt demonstrate better physical properties over the same polymer composition comprising a carboxy phosphinic acid compound. For example, a polymer composition comprising 100 parts by weight of ABS polymer resin and 30 parts by weight of a carboxylate phosphinate salt compound demonstrate better thermal resistance, thermal stability of the sample color, and hygroscopicity over the counterpart polymer composition comprising 100 parts by weight of ABS polymer resin and 30 parts by weight of a carboxy phosphinic acid. Tables 1, 2, and 3 illustrate these results.

In some embodiments, the molded articles of the polymer composition comprising the polymer resin and the carboxylate phosphinate salt compound demonstrate good flame retardancy. The molded article of the polymer composition may have a flame retardancy of at least V-1 when a specimen of the composition is tested according to UL-94VB at a thickness of 1/10″. The molded article of the polymer composition may have a flame retardancy of V-0 when a specimen of the composition is tested according to UL-94VB at a thickness of 1/10″.

Some embodiments of the composition having good flame retardancy comprise: 100 parts by weight of a thermoplastic resin, 0.1-50 parts by weight of a carboxy phosphinic acid salt compound. Other embodiments may also include 0-50 parts by weight of an aromatic phosphoric acid ester compound.

In embodiments, a polymer composition for making a molded article comprises a polymer resin and a carboxylate phosphinate salt compound. According to embodiments, the polymer composition may contain one or more compounds or polymers in addition to the foregoing components. Additional components or additives may be added to provide additional properties or characteristics to the polymer composition or to modify existing properties of the composition. For example, an inorganic filler such as glass fiber, carbon fiber, talk, silica, mica, and alumina may be added to improve mechanical strength and heat distortion temperature of the resin composition. In addition, the polymer composition may further include a heat stabilizer, an anti-oxidant, an ultraviolet absorbing agent, a light stabilizer, a flame retardant, a lubricant, a pigment and/or dye. One of ordinary skill in the art will appreciate that various additives may be added to the polymer compositions according to embodiments of the invention.

In embodiments, the polymer compositions are prepared by mixing their components including a thermoplastic resin and a carboxylate phosphinate salt compounds. In some embodiments, one or more other additives may be mixed together with the components of the polymer composition. In some embodiments, one or more component resins may be heated to melt prior to the mixing or the composition may be heated during the mixing. The mixing may occur when each components is in a solid, liquid, or dissolved state, or mixtures thereof. In one embodiment, the above components are mixed together all at once. Alternatively, one or more components are added individually. For example, the thermoplastic resin may be mixed with filler, prior to mixing this admixture with the remaining components. Formulating and mixing the components may be made by any method known to those persons having ordinary skill in the art, or those methods that may be later discovered. The mixing may occur in a pre-mixing state in a device such as a ribbon blender, followed by further mixing in a Henschel mixer, Banbury mixer, a single screw extruder, a twin screw extruder, a multi screw extruder, or a cokneader.

Another embodiment provides a molded article using the polymer composition according to the foregoing embodiments. The polymer compositions are molded into various shapes. For molding with the composition, an extrusion molding machine such as a vented extruder may be used. The polymer composition of embodiments may be molded into various moldings using, for example, a melt-molding device. In embodiments, the polymer composition is formed into a pellet, which then may be molded into various shapes using, for example, injection molding, injection compression molding, extrusion molding, blow molding, pressing, vacuum forming or foaming. In one embodiment, the polymer composition can be made into a pellet using melt-kneading, and the resulting pellets are molded into moldings through injection molding or injection compression molding.

As noted, in one embodiment, the polymer compositions are formed into pellets. In other embodiments, the polymer compositions are formed into structural parts of various consumer products, including electronic devices and appliances. In some embodiments, the polymer compositions are molded into a housing or body of electronic or non-electronic devices. Examples of electrical devices in which a molded article made of the blend of the composition according to embodiments of the invention include printers, computers, word processors, keyboards, personal digital assistants (PDA), telephones, mobile phones, facsimile machines, copy machines, electronic cash registers (ECR), desk-top electronic calculators, PDAs, cards, stationery holders, washing machines, refrigerators, vacuum cleaners, microwave ovens, lighting equipment, irons, TV, VTR, DVD players, video cameras, radio cassette recorders, tape recorders, mini disc players, CD players, speakers, liquid crystal displays, MP3 players, and electric or electronic parts and telecommunication equipment, such as connectors, relays, condensers, switches, printed circuit boards materials, coil bobbins, semiconductor sealing materials, electric wires, cables, transformers, deflecting yokes, distribution boards, clocks, watches, and the like.

Another embodiment provides an electronic device which includes a housing or a part, which is made of a polymer composition comprising a thermoplastic resin. and a carboxylate phosphinate salt compound.

Polymer Resin

In embodiments, the molded article comprises a polymer resin. Some embodiments may comprises a thermoplastic resin. Other embodiments may comprise a thermosetting resin. Embodiments can also include mixtures of thermoplastic and thermosetting resin.

Examples of the thermoplastic resin include, but are not limited to, polystyrene resin (PS resin), acrylonitrile-butadiene-styrene copolymer resin (ABS resin), acrylonitrile-styrene copolymer resin (SAN resin), rubber-modified polystyrene resin (HIPS), acrylonitrile-styrene-acrylate copolymer resin (ASA resin), methylmethacrylate-butadiene-styrene copolymer resin (MBS resin), acrylonitrile-ethylacrylate-styrene copolymer resin (AES resin), polycarbonate resin (PC), polyphenylene ether resin (PPE), polyethylene resin (PE), polypropylene resin (PP), polyethylene terephthalate (PET), polybutylene terephthalate (PBT), polymethyl methacrylate (PMMA), polyamide resin (PA), and copolymers or mixtures thereof.

Carboxylate Phosphinate Acid Salt Compound

In embodiments, the polymer composition comprises a carboxylate phosphinate salt compounds. Some embodiments of the molded article may comprises more than one carboxylate phosphinate salt. These carboxylate phosphninc salt compounds may have different substituents, metal ions, charges, and so forth.

In some embodiments, the carboxylate phosphinate salt compound is:

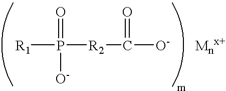

wherein R₁ is a C₁-C₆ alkyl group, a C₃-C₁₀ cycloalkyl group or a C₆-C₁₀ aryl group, R₂ is a C₁-C₆ alkylene group, a C₃-C₁₀ cycloalkylene group or a C₆-C₁₀ arylene group, M is Al, Zn, Ca, or a melamine, m and n are independently integers ranging from 1 to 3, and x is an integer selected so that the net charge of the carboxylate phosphinate salt compound is 0.

In some embodiments, R₁ is alkyl. In some of these embodiments where R₁ is alkyl, R₁ may be independently selected methyl, ethyl, propyl and butyl. These alkyl groups may be substituted or unsubstituted.

In other embodiments, R₂ is an alkylene group. In some of these embodiments where R₂ is alkylene, R₂ may be selected from methylene, ethylene, propylene or butylene group. These alkylene groups may be substituted or unsubstituted.

In some embodiments, M is Al or Zn.

In embodiments, the carboxylate phosphinate salt compounds may be used alone or in a mixture, in an amount of 0.1-50 parts by weight, and preferably 0.5-40 parts by weight, based on 100 parts by weight of the thermoplastic resin.

Aromatic Phosphoric Acid Ester Compound

In some embodiments include an aromatic phosphoric acid ester compound.

In embodiments, this acid ester phosphoric compound may be represented by the following formula: 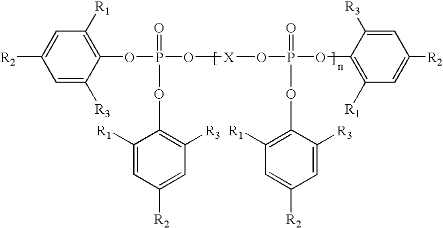
wherein R₁, R₂ and R₃ on each phenyl group are each independently hydrogen or C₁₋₄ alkyl and are independent of R₁, R₂, and R₃ on a different phenyl group;
X is derived from a compound comprising two hydroxyaryl groups;
and n is0to4.

In some embodiments, X may be derived from a dialcohol. In some embodiments, X may be derived from one selected from resorcinol, hydroquinone, bisphenol A, or derivatives of these compounds. In these particular compounds, the O—X—O shown in the above formula represents the oxygens of the compound comprising two hydroxyaryl groups. In some embodiments, the O—X—O shown in the above formula represents the two oxygen atoms of resorcinol hydroquinone, or bisphenol A.

Examples of the aromatic phosphoric acid ester compound corresponding to the above formula where n is 0 include, but are not limited to triphenylphosphate, tricresylphosphate, trixylenylphosphate, tri(2,6-dimethylphenyl)phosphate, tri (2,4,6-trimethylphenyl)phosphate, tri(2,4-di-tert-butylphenyl)phosphate, tri(2,6-di-tert -butylphenyl)phosphate. Examples of the aromatic phosphoric acid ester compound corresponding to the above forumla corresponding where n is 1 include, but are not limited to, resorcinol bis(diphenyl)phosphate, resorcinol bis(2,6-dimethylphenyl)phosphate, resorcinol bis(2,4-di-tert-butylphenyl)phosphate, hydroquinol bis(2,6-dimethylphenyl)phosphate, hydroquinol bis(2,4-di-tert-butylphenyl)phosphate.

In embodiments, more than one aromatic ester compound may be used in embodiments. In some embodiments, the molded composition may comprise the aromatic phosphoric acid ester compound from about 0.1 to about 50 parts by weight, based on 100 parts by weight of the thermoplastic resin. In other embodiments the molded composition may comprise the aromatic phosphoric acid ester compound from about 0.1 to about 30 parts by weight, based on 100 parts by weight of the thermoplastic resin. Some embodiments include about 0.1, 0.2, 0.5, 1, 1.5, 2, 3, 4, 5, 6, 7, 8, 9, 10, 11, 12, 13, 14, 15, 16, 17, 18, 19, 20, 21, 22, 23, 24, 25, 26, 27, 28, 29, 30 parts by weight, based on 100 parts by weight of the thermoplastic resin.

The inventive resin composition can be prepared using any conventional method for preparing resin compositions. Also, the inventive thermoplastic resin composition may also contain at least one additive selected from the group consisting of a conventional flame retardant, a plasticizer, a thermal stabilizer, an antioxidant, a compatibilizer, a light stabilizer, a pigment, a dye and an inorganic additive. Examples of the inorganic additive include asbestos, glass fiber, talc, ceramic and sulfate, and these optional additives can be used in an amount of 0-50 parts by weight based on the total weight of the composition.

Hereinafter, the present invention will be described in detail using examples. It is to be understood, however, that these examples are for illustrative purpose only and are not construed to limit the scope of the present invention.

Components used in Examples of the present invention and Comparative Examples have the following specifications.
(A) Thermoplastic resin
(A1) Rubber-modified SAN copolymer resin (ABS resin)
(A1-1) g-ABS resin

To butadiene rubber latex having a solid content of 50 parts by weight, 35 parts by weight of styrene, 14 parts by weight of acrylonitrile and 150 parts by weight of deionized water were added. To the mixture, 1.0 part by weight of potassium oleate, 0.4 parts by weight of cumen hydroperoxide, 0.2 parts by weight of a mercaptan chain transfer agent, 0.4 parts by weight of glucose, 0.01 parts by weight of iron sulfate hydrate and 0.3 parts by weight of sodium pyrophosphate were added and allowed to react at 75° C. for 5 hours, thus preparing graft ABS latex. To the latex, sulfuric acid was added in an amount of 0.4 parts by weight based on the solid content of the latex, and the resulting latex was solidified, thus preparing graft copolymer resin (g-ABS) as powder.
(A1-2) SAN Copolymer Resin

75 parts by weight of styrene, 25 parts by weight of acrylonitrile, 120 parts by weight of deionized water, 0.15 parts by weight of azobisisobutyronitrile, 0.4 parts by weight of tricalcium phosphate and 0.2 parts by weight of a mercaptan chain transfer agent were mixed with each other. The mixture was heated from room temperature to 80° C. over a period of 90 minutes and maintained at that temperature for 180 minutes, thus preparing copolymer resin (SAN). It was washed with water, dewatered and dried, thus preparing SAN powder.

30 parts by weight of the component (A11) was compounded with 70 parts by weight of the component (A12) to obtain a rubber-modified SAN copolymer resin.
(A2) Rubber-Reinforced Polystyrene Copolymer (HIPS Resin)

A rubber-modified polystyrene resin prepared using a conventional method was used, in which the rubber content was 9 wt %, the average rubber particle size was 1.5 μm, and the weight average molecular weight of polystyrene was 200,000.
(A3) Polyphenylene Ether Resin (PPE Resin)

Poly(2,6-dimethylphenylether), which is commercially available under the trade name of S-202 from Asahi Kasei Corporation, Japan, and which is in the form of powder having an average particle size of several tens of μm, was used.
(A4) Glass-Reinforced Polybutylene Terephthalate Resin (Glass Reinforced PBT Resin)

70% polybutylene terephthalate (commercially available under the trade name of Tribit 1500 from Samyang Corporation, Korea), reinforced with 30% glass fiber, was used.
(B) Carboxylate Phosphinate Acid Salt Compound
(B1) 3-(hydroxymethylphosphionyl)propionic acid aluminum salt, which is commercially available from Clariant Corporation in the form of powder, was used.
(B2) 3-(hydroxymethylphosphionyl)propionic acid calcium salt, which is commercially available from Clariant Corporation in the form of powder, was used.
(B3) 3-(hydroxymethylphosphionyl)propionic acid zinc salt, which is commercially available from Clariant Corporation in the form of powder, was used.
(B4) 3-(hydroxymethylphosphionyl)propionic acid melamine salt, which is commercially available from Clariant Corporation was used which is in the form of powder, was used.
(C) Aromatic Phosphoric Acid Ester Compound

Resorcinol bis(2,6-dimethylphenyl)phosphate, commercially available under the trade name of PX200 from Daihachi Chemical Industry Co., Ltd., Japan, was used.
(D) Carboxylate Phosphinate Acid Compound

3-(hydroxymethylphosphionyl)propionic acid, which is commercially available from Clariant Corporation which is in the form of white powder, was used.

The components described above were mixed according to the composition shown in Table 1 below, and the mixture was extruded through a conventional twin-screw extruder at a temperature of 200-280° C. to prepare pellets. The prepared pellets were dried at 80° C. for 2 hours and then injected through a 6-Oz injector at a molding temperature of 180-280° C. and a mold temperature of 40-80° C., thus preparing test samples. The prepared samples were measured for physical properties in the following manner.

Flammability: rated according to UL 94 VB class at a thickness of 1/10″.

Izod impact strength: measured according to the test method of ASTM 256A at a thickness of ⅛″.

Thermal resistance: measured according to ASTM D 1525 at a load of 5 kgf.

Also, to examine the thermal stability of the sample color, the test samples were allowed to sit in a 6-Oz injector using a pinpoint gate mold at 270° C. for 10 minutes so as to inject samples having a size of 5 cm×20 cm, and the injected samples before sitting and the injected samples after sitting were observed visually and with a Minolta spectrophotometer. Hygroscopicity was measured by standing injected samples having a size of 10 cm×10 cm in a constant temperature and humidity chamber at a temperature of 60° C. and a humidity of 90% for 24 hours and then measuring the difference in sample weight beforehand and thereafter.

TABLE 1

| | | Examples | | | | | | | |
|---|---|---|---|---|---|---|---|---|---|
| | | 1 | 2 | 3 | 4 | 5 | 6 | 7 | 8 |
| (A1) ABS | | 100 | 100 | 100 | 100 | 100 | 100 | 100 | 100 |
| (A2) HIPS | | — | — | — | — | — | — | — | — |
| (A3) PPE | | — | — | — | — | — | — | — | — |
| (A4) PBT | | — | — | — | — | — | — | — | — |
| (B) | (B1) Al | 40 | — | — | — | 30 | — | — | — |
| Carboxylate | (B2) Ca | — | 40 | — | — | — | 30 | — | — |
| Phosphinate | (B3) Zn | — | — | 40 | — | — | — | 30 | — |
| Salt | (B1) | — | — | — | 40 | — | — | — | 30 |
| | melamine | | | | | | | | |

| | | | | | | | | |
|---|---|---|---|---|---|---|---|---|
| (C) Phosphoric acid ester | — | — | — | — | 10 | 10 | 10 | 10 |
| U94 flame class ( 1/10″) | V-0 | V-0 | V-1 | V-1 | V-1 | V-0 | V-0 | V-0 |
| Thermal resistance (° C.) | 90 | 87 | 94 | 92 | 93 | 93 | 80 | 88 |
| Thermal stability of sample | Good | Good | Good | Good | Good | Good | Good | Moderate |
| color | | | | | | | | |
| Hygroscopicity (%) | 1.5 | 1.7 | 0.6 | 0.9 | 0.3 | 0.4 | 0.3 | 0.3 |

TABLE 2

| | | Examples | | | | | |
|---|---|---|---|---|---|---|---|
| | | 9 | 10 | 11 | 12 | 13 | 14 |
| (A1) ABS | | — | — | — | — | — | — |
| (A2) HIPS | | 100 | 70 | 75 | 70 | 70 | — |
| (A3) PPE | | — | 30 | 25 | 20 | 30 | — |
| (A4) PBT | | — | — | — | 10 | — | 100 |
| (B) | (B1) Al | 40 | 15 | 10 | 15 | 5 | 23 |
| Carboxylate | (B2) Ca | — | — | — | — | — | — |
| Phosphinate | (B3) Zn | — | — | — | — | — | — |
| Salt | (B1) | — | — | — | — | — | — |
| | melamine | | | | | | |

| | | | | | | |
|---|---|---|---|---|---|---|
| (C) Phosphoric acid ester | — | — | 5 | — | 15 | — |
| U94 flame class ( 1/10″) | V-0 | V-0 | V-0 | V-0 | V-0 | V-0 |
| Thermal resistance (° C.) | 84 | 115 | 107 | 110 | 92 | 200 |
| Thermal stability of | Good | Good | Good | Good | Good | Good |
| sample color | | | | | | |
| Hygroscopicity (%) | 1.5 | 0.7 | 0.4 | 0.5 | 0.3 | 1.0 |

TABLE 3

| | Comparative Examples | | | | | | | | |
|---|---|---|---|---|---|---|---|---|---|
| | 1 | 2 | 3 | 4 | 5 | 6 | 7 | 8 | 9 |
| (A1) ABS | 100 | 100 | 100 | — | — | — | — | — | — |
| (A2) HIPS | — | — | — | 100 | 80 | 75 | 75 | 70 | — |
| (A3) PPE | — | — | — | — | 20 | 25 | 20 | 30 | — |
| (A4) PBT | — | — | — | — | — | — | — | — | 100 |
| (B) Carboxylate | — | — | — | — | — | — | — | — | — |
| Phosphinate Salt | | | | | | | | | |
| (C) Phosphoric acid ester | — | — | 30 | — | — | 5 | 15 | 17 | — |
| (D) Carboxy phosphinic | 20 | 30 | | 30 | 15 | 10 | | | 23 |
| acid | | | | | | | | | |
| U94 flame class ( 1/10″) | Fail | V-0 | Fail | V-0 | V-0 | V-0 | Fail | V-1 | V-0 |
| Thermal resistance (° C.) | 70 | 67 | 66 | 63 | 89 | 85 | 82 | 85 | 160 |
| Izod impact strength | — | — | — | 10 | 11 | 11 | 15 | 13 | — |
| Thermal stability of | Bad | Bad | Good | Bad | Bad | Bad | Good | Good | Moderate |
| sample color | | | | | | | | | |
| Hygroscopicity (%) | 3.0 | 5.0 | 0.3 | 4.9 | 2.5 | 1.5 | 0.3 | 0.3 | 4.2 |

As can be seen from the results of Examples 1-8 in Table 1 above, the use of the carboxylate phosphinate salt compound as a flame retardant shows excellent flame retardancy and thermal resistance at a thickness of 1/10″ compared to the single use of the aromatic phosphoric acid compound, and also shows a great improvement in thermal stability and color thermal stability, compared to the use of the carboxylate phosphinate saltcompound.

As can be seen from the results in Table 2 above, the use of the carboxylate phosphinate salt compound in Examples 9 and 10 shows good thermal resistance and flame retardancy. Also, the use of the carboxylate phosphinate salt compound in combination with the aromatic phosphoric acid ester compound in Examples 11-13 shows a great improvement in flame retardancy and thermal resistance at a thickness of 1/10″ compared to the single use of the aromatic phosphoric acid ester compound in Comparative Examples 7 and 8, and also has an increase in flame retardancy due to synergistic effects. In addition, the use of the known carboxy phosphinic acid in Comparative Examples 1-6 shows a great reduction in color thermal stability and hygroscopicity.

As described above, the present invention provides a flame-retardant thermoplastic resin composition, which has fire stability, is eco-friendly because it does not use a halogenated flame retardant causing environmental pollution upon burning, and has excellent thermal stability and low hygroscopicity.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of embodiments herein.

What is claimed is:

1. A polymer composition comprising:
a polymer resin;
and a carboxylate phosphinate acid salt compound.

2. The polymer composition of claim 1, wherein the carboxylate phosphinate acid salt compound is 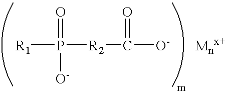
wherein R₁ is independently selected from a C₁-C₆ alkyl group, a C₃-C₁₀ cycloalkyl group, and a C₆-C₁₀ aryl group;
R₂ is independently selected from a C₁-C₆ alkylene group, a C₃-C₁₀ cycloalkylene group, and a C₆-C₁₀ arylene group;
M is selected from the group consisting of Al, Zn, Ca, and a melamine;
m and n are independently an integer from 1 to 3;
and x is an integer selected so that the net charge of the carboxylate phosphinate acid salt compound is 0.

3. The polymer composition of claim 1, wherein the polymer composition is substantially free of halogen-containing compounds.

4. The polymer composition of claim 1, wherein the polymer resin is a thermoplastic resin

5. The polymer composition of claim 1, wherein the polymer resin is one or a mixture of two or more selected from the group consisting of polystyrene resin (PS resin), acrylonitrile-butadiene-styrene copolymer resin (ABS resin), rubber-modified polystyrene resin (HIPS resin), acrylonitrile-styrene-acrylate copolymer resin (ASA resin), acrylonitrile-styrene copolymer resin (SAN resin), methylmethacrylate-butadiene-styrene copolymer resin (MBS resin), acrylonitrile-ethylacrylate-styrene copolymer resin (AES resin), polycarbonate resin (PC), polyphenylene ether resin (PPE), polyethylene resin (PE), polypropylene resin (PP), polyethylene terephthalate (PET), polybutylene terephthalate (PBT), polymethyl methacrylate (PMMA), polyamide resin (PA), and copolymers thereof.

6. The polymer composition of claim 1, further comprising 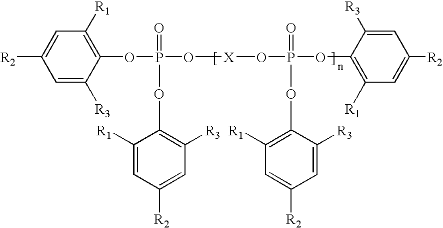
wherein R₁, R₂ and R₃ on each phenyl group are each independently hydrogen or C₁₋₄ alkyl and are independent of R₁, R₂, and R₃ on a different phenyl group;
X is derived from a compound comprising two hydroxyaryl groups;
and n is 0 to 4.

7. The polymer composition of claim 1, wherein the polymer composition comprises the polymer resin from about 60 to about 99.9 parts, and the carboxylate phosphinate acid salt compound from about 0.1 to about 40 parts by weight, based on the polymer resin and the carboxylate phosphinate acid salt compound totaling 100 parts by weight.

8. The polymer composition of claim 1, wherein the polymer composition comprises the polymer resin from about 70 to about 98 parts, and the carboxylate phosphinate acid salt compound from about 2 to about 30 parts by weight, based on the polymer resin and the carboxylate phosphinate acid salt compound totaling 100 parts by weight.

9. The polymer composition of claim 1, wherein the polymer composition comprises the polymer resin from about 75 to about 97 parts, and the carboxylate phosphinate acid salt compound from about 3 to about 25 parts by weight, based on the polymer resin and the carboxylate phosphinate acid salt compound totaling 100 parts by weight.

10. The polymer composition of claim 1, wherein the polymer composition comprises the polymer resin from about 75 to about 95 parts, and the carboxylate phosphinate acid salt compound from about 5 to about 25 parts by weight, based on the polymer resin and the carboxylate phosphinate acid salt compound totaling 100 parts by weight.

11. The polymer composition of claim 1, wherein the polymer composition comprises the polymer resin from about 80 to about 92 parts, and the carboxylate phosphinate acid salt compound from about 8 to about 20 parts by weight, based on the polymer resin and the carboxylate phosphinate acid salt compound totaling 100 parts by weight.

12. A molded article comprising the polymer composition of claim 1.

13. The molded article of claim 12, wherein the molded article has flame retardancy of at least V-1 when a specimen of the composition is tested according to UL-94VB at a thickness of 1/10″.

14. The molded article of claim 12, wherein the molded article has flame retardancy of V-0 when a specimen of the composition is tested according to UL-94VB at a thickness of 1/10″.

15. The molded article of claim 12, wherein the article exhibits good thermal stability of sample color when a specimen of the composition is exposed to 270° C. for 10 minutes.

16. The molded article of claim 12, wherein the article exhibits a hygroscopicity less than 1.8%.

17. A method of making a plastic structure, the comprising:
providing the polymer composition of claim 1; and
molding the polymer composition into a shape.

18. A method of making an electronic device, the method comprising:
providing an electronic circuit;
providing a housing substantially enclosing the electronic circuit, the housing comprising a portion, which comprises the polymer composition of claim 1.

19. An electronic device comprising a housing, wherein the housing comprises a portion comprising the polymer composition of claim 1.
